(19) United States
(12) Patent Application Publication
(10) Pub. No.: US 2026/0186652 A1
(43) Pub. Date: Jul. 2, 2026

(54) OPERATION METHOD OF STORAGE CONTROLLER FOR PROCESSING COPY COMMAND, STORAGE DEVICE, AND MEMORY SYSTEM

(71) Applicant: SAMSUNG ELECTRONICS CO., LTD., Suwon-si (KR)

(72) Inventors: Yull Kim, Suwon-si (KR); Junhee Kim, Suwon-si (KR); Jungtae Lee, Suwon-si (KR)

(73) Assignee: SAMSUNG ELECTRONICS CO., LTD., Suwon-si (KR)

(21) Appl. No.: 19/391,079

(22) Filed: Nov. 17, 2025

(30) Foreign Application Priority Data
Nov. 25, 2024 (KR) 10-2024-0170114

(51) Int. Cl. G06F 3/06

(52) U.S. Cl. CPC G06F 3/0608; G06F 3/064; G06F 3/0659; G06F 3/0679

(57) ABSTRACT

An operation method of a storage controller is provided, receiving a copy command, a source logic block address (LBA), and a destination LBA from a host; reading target data at a first location corresponding to the source LBA, based on logical to physical (L2P) map information, and loading the target data into a static random access memory (SRAM); and writing the target data to a data area of a new block at a second location and writing the source LBA and the destination LBA to a spare area of the new block.

### CROSS-REFERENCE TO RELATED APPLICATION

This application is based on and claims priority under 35 U.S.C. § 119 to Korean Patent Application No. 10-2024-0170114, filed on Nov. 25, 2024, in the Korean Intellectual Property Office, the disclosure of which is incorporated by reference herein in its entirety.

### BACKGROUND

The disclosure relates to storage controllers, and more particularly, to an operation method of a storage controller for processing a copy command, a storage device, and a memory system.

Universal flash storages (UFSs) are storage interfaces that support high-speed data transmission, and may be widely used in compact electronic apparatuses, such as mobile apparatuses. According to the UFS 4.0 standard of the Joint Electron Device Engineering Council (JEDEC), which defines the standard specifications for UFS devices, connection between a host and an UFS device may be implemented in a 2-LANE manner.

When a host wants to copy specific data, the host must first read target data through a read command from a storage device and load the read-out target data into the host's static random access memory (SRAM), and must transfer the target data back to the storage device with a new address through a write command in order to write the target data to a different location. This operation causes duplicate IO occurrence and unnecessary power consumption. To address this inefficiency, a copy command was introduced into a UFS to improve this inefficiency.

### SUMMARY

The disclosure provides securement of a free space by performing many-to-one mapping between logical addresses and physical addresses without fear of data loss when performing a copy command.

The technical problems of the disclosure are not limited to the above-mentioned technical problems, and other technical problems not mentioned will be clearly understood by a person skilled in the art from the following description.

According to an aspect of an example embodiment of the disclosure, there is provided an operation method of a storage controller, the operation method including the operation of receiving a copy command, a source logic block address (LBA), and a destination LBA from a host, the operation of reading target data at a first location corresponding to the source LBA, based on logical to physical (L2P) map information, and loading the target data into a static random access memory (SRAM), and the operation of writing the target data to a data area of a new block at a second location and writing the source LBA and the destination LBA to a spare area of the new block.

According to an aspect of an example embodiment of the disclosure, there is provided a storage device including a plurality of non-volatile memory devices and a storage controller, wherein the storage controller is configured to receive a copy command, a source logic block address (LBA), and a destination LBA from a host, read target data at a first location corresponding to the source LBA, based on logical to physical (L2P) map information, load the target data into a static random access memory (SRAM), write the target data to a data area of a new block at a second location, and write the source LBA and the destination LBA to a spare area of the new block.

According to an aspect of an example embodiment of the disclosure, there is provided a memory system including a host configured to transmit, to a storage device, a copy command requesting that data at a source logic block address (LBA) is copied to a destination LBA, and a storage device including a storage controller, wherein the storage controller is configured to receive a copy command, a source LBA, and a destination LBA from a host, read target data at a first location corresponding to the source LBA, based on logical to physical (L2P) map information, and load the target data into a static random access memory (SRAM), write the target data to a data area of a new block at a second location, and write the source LBA and the destination LBA to a spare area of the new block.

### BRIEF DESCRIPTION OF DRAWINGS

Example embodiments will be more clearly understood from the following detailed description taken in conjunction with the accompanying drawings in which:

FIG. 1 is a block diagram for describing a universal flash storage (UFS) system according to one or more embodiments;

FIG. 2 is a block diagram illustrating an embodiment of a UFS host of FIG. 1;

FIG. 3 is a block diagram of an implementation of a storage device according to one or more embodiments;

FIG. 4 illustrates changes in a logical-to-physical (L2P) map and a storage status according to a UFS copy command, according to a comparative example;

FIG. 5 illustrates changes in an L2P map and a storage status according to a UFS copy command, according to a comparative example;

FIG. 6 is a flowchart of an operation method of a storage controller, according to one or more embodiments;

FIG. 7 illustrates changes in an L2P map and a storage status based on a UFS copy command, according to one or more embodiments;

FIG. 8 is a graph showing a change in a fill ratio according to the number of copy commands, according to one or more embodiments; and

FIG. 9 is a block diagram of a system including a storage device, according to one or more embodiments.

### DETAILED DESCRIPTION

Hereinafter, the disclosure will be described more fully with reference to the accompanying drawings, in which embodiments of the disclosure are shown. In the drawings, like elements are denoted by like reference numerals, and a repeated explanation thereof will not be given.

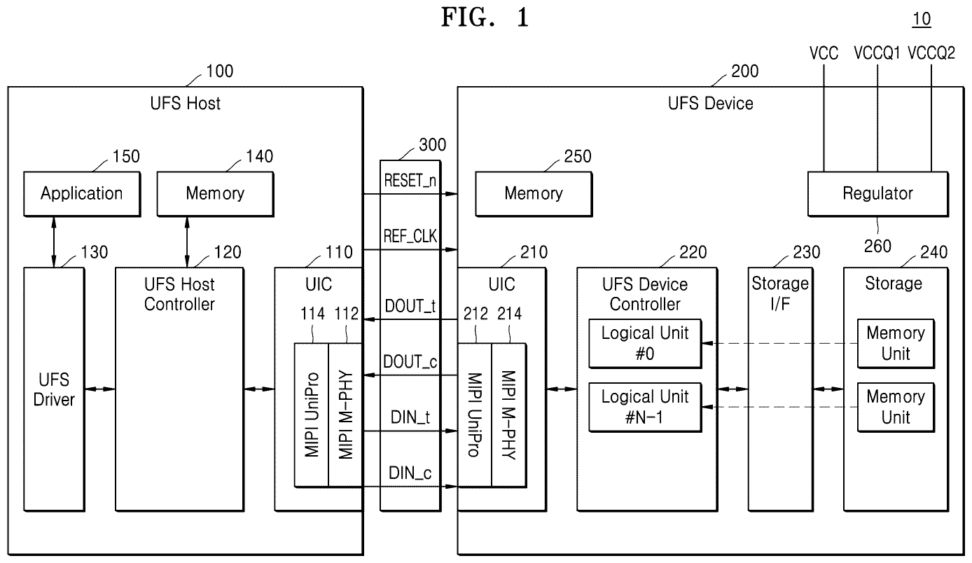

FIG. 1 is a block diagram for describing a universal flash storage (UFS) system 10 according to one or more embodiments.

The UFS system 10 complies with a UFS standard proposed by the Joint Electron Device Engineering Council (JEDEC), and may include a UFS host 100, a UFS device 200, and a UFS interface (I/F) 300.

According to an embodiment, the UFS host 100 and the UFS device 200 may be connected to each other via the UFS I/F 300.

According to an embodiment, the UFS host 100 may include an application 150, a UFS driver 130, a UFS host controller 120, a memory 140, and a UFS interconnect (UIC) layer 110.

According to an embodiment, the UFS device 200 may include a UFS device controller 220, a storage 240, a storage I/F 230, a memory 250, a regulator 260, and an UIC layer 210. The storage 240 may be configured as a plurality of non-volatile memory units (or plurality of non-volatile memory devices).

The application 150 may refer to a program that wants to communicate with the UFS device 200 in order to use a function of the UFS device 200. The application 150 may transmit an input-output request (IOR) to the UFS driver 130 in order to achieve an input/output for the UFS device 200. The IOR may refer to a read request, a write request, a discard request, and/or a copy request of data, but the disclosure is not limited thereto.

The UFS driver 130 may manage the UFS host controller 101 through a UFS-host controller interface (UFS-HCI). The UFS driver 130 may convert the IOR generated by the application 150 into a UFS command defined by the UFS standard, and may transmit the UFS command to the UFS host controller 120. One IOR may be converted into a plurality of UFS commands. A UFS command may be basically a command defined by a Small Computer System Interface (SCSI) standard, but may also be a command dedicated to the UFS standard.

The UFS host controller 120 may transmit the UFS command obtained by the UFS driver 130 to the UIC layer 210 of the UFS device 200 via the UIC layer 110 of the UFS host 100 and the UFS I/F 300.

The UIC layer 110 included in the UFS host 100 may include an Mobile Industry Processor Interface (MIPI) Unified Protocol (UniPro) 114 and an MIPI Mobile-PHYsical (M-PHY) 112, and the UIC layer 210 included in the UFS device 200 may include an MIPI M-PHY 212 and an MIPI UniPro 214.

The UFS I/F 300 may include a line for transmitting a reference clock REF_CLK, a line for transmitting a hardware reset signal RESET_n for the UFS device 200, a pair of lines for transmitting a pair of differential input signals DIN_t and DIN_c, and a pair of lines for transmitting a pair of differential output signals DOUT_t and DOUT_c.

A frequency value of a reference clock provided from the UFS host 100 to the UFS device 200 may be one of four values of 19.2 MHz, 26.0 MHz, 38.4 MHz, and 52.0 MHz, but the disclosure is not limited thereto.

The UFS host 100 may change the frequency value of the reference clock even while operating, that is, while data transmission/reception is being performed between the UFS host 100 and the UFS device 200. The UFS device 200 may generate clocks of various frequencies from the reference clock provided from the UFS host 100, by using a phase-locked loop (PLL) or the like.

The UFS I/F 300 may support a plurality of lanes, each of which may be implemented as a differential pair. For example, the UFS I/F 300 may include at least one receive lane and at least one transmit lane, the pair of lines for transmitting the pair of differential input signals DIN_t and DIN_c may correspond to the receive lane, and the pair of lines for transmitting the pair of differential output signals DOUT_t and DOUT_c may correspond to the transmit lane.

The at least one receive lane and the at least one transmit lane may transmit data in a serial communication manner, and full-duplex communication may be possible between the UFS host 100 and the UFS device 200 based on a structure in which the at least one receive lane is separated from the at least one transmit lane.

When a command from the UFS host 100 is input to the UFS device 200 via the UIC layer 210, the UFS device controller 220 may perform an operation according to the input command, and, when the operation is completed, may transmit a completion response to the UFS host 100.

For example, when the input command is a write command, the UFS device controller 220 may temporarily store write data received from the UFS host 100 in the memory 250. The UFS device controller 220 may store the write data temporarily stored in the memory 250, at a selected location of a non-volatile memory block, through the storage I/F 230.

The UFS device controller 220 may manage the storage 240 through a logical unit (LU), which is a logical data storage unit. A number of LUs may be, but is not limited to, 8.

The UFS device controller 220 may include a flash translation layer (FTL), and may convert a logical data address, for example, a logical block address (LBA), received from the UFS host 100 into a physical data address, for example, a physical block address (PBA), by using the FTL. In the UFS system 10, a minimum size of a logical block for storing user data may be set to be 4 Kbytes.

Each of a plurality of memory units may include a memory cell array and a control circuit for controlling an operation of the memory cell array. The memory cell array may include a two-dimensional memory cell array or a three-dimensional memory cell array. The memory cell array may include a plurality of memory cells, each of which may be a cell storing information of one bit (a single level cell (SLC)) or may be a cell storing information of two or more bits, such as a multi-level cell (MLC), a triple level cell (TLC), or a Quadruple Level Cell (QLC). The three-dimensional memory cell array may include vertical NAND strings that are vertically oriented such that at least one memory cell is positioned on top of another memory cell.

VCC, VCCQ1, VCCQ2, etc. may be input as a power supply voltage of the UFS device 200. VCC, which is a main power supply voltage for the UFS device 200, may have a value of 2.4 V to 3.6 V. VCCQ1, which is a power supply voltage for supplying a low-range voltage, may be provided mainly for the UFS device controller 220, and may have a value of 1.14 V to 1.26 V. VCCQ2, which is a power supply voltage for supplying a voltage lower than VCC but higher than VCCQ1, may be provided mainly for input/output I/Fs such as MIPI M-PHY, and may have a value of 1.7 V to 1.95 V. The power supply voltages may be supplied for each of the components of the UFS device 200 via the regulator 260.

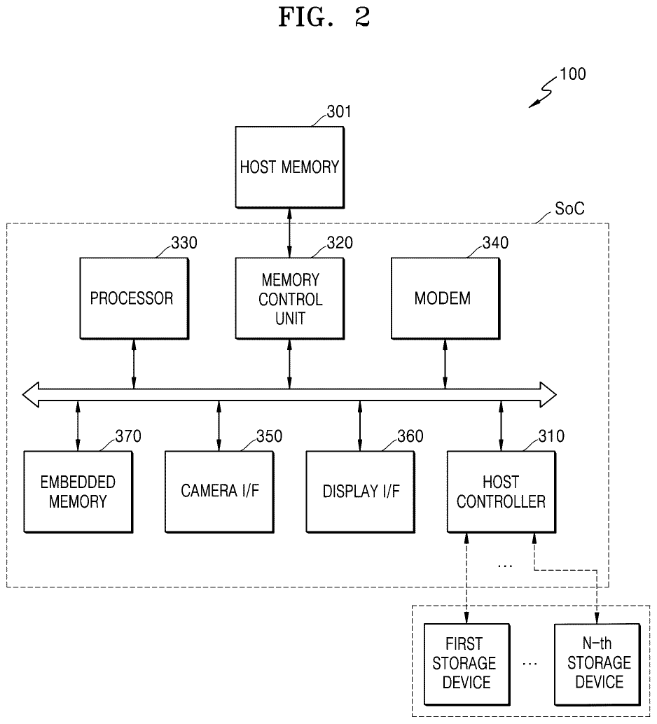

FIG. 2 is a block diagram illustrating an embodiment of the UFS host of FIG. 1.

A host 100 of FIG. 2 may correspond to the UFS host 100 of FIG. 1. In the example of FIG. 2, the host 100 may include a system on chip SoC and a host memory 301, and a processor 330 that controls a memory operation by executing software stored in the host memory 301 is illustrated. However, the host memory 301 may be provided within the system on chip SoC, or an embedded memory 370 may perform a function of the host memory 301. The system on a chip SoC may be an application processor (AP).

Referring to FIG. 2, the system on chip SoC may include one or more intellectual property (IP) modules. For example, the system on chip SoC may include a host controller 310, a memory control unit 320, a processor 330, a modem 340, a camera I/F 350, a display I/F 360, and the embedded memory 370.

The processor 330 may control overall operations of the system on chip SoC. For example, software (e.g., a host application and a device driver) for managing data write/read operations for a storage device may be loaded into the host memory 301, and the processor 330 may manage data write/read operations, etc. by executing the software. The host memory 301 may be implemented as a volatile memory and/or a non-volatile memory. For example, the host memory 301 may include a volatile memory, such as a dynamic random access memory (DRAM) and/or a static random access memory (SRAM).

According to an embodiment, the system on chip SoC may perform a camera control operation, a display control operation, and a communication operation by including the modem 340, the camera I/F 350, and the display I/F 360. In FIG. 2, as the modem 340 is included in the system on chip SoC corresponding to an AP, the system on chip SoC may be referred to as a modem application processor (ModAP).

The host controller 310 may transmit and receive a packet to and from the storage device according to the above-described embodiment. In response to an access request generated by a host application layer of the system on chip SoC, the host controller 310 may generate a packet according to a preset interface and provide the packet with a number of storage devices. For example, a memory package according to an embodiment may include first through N-th storage devices (where N is an integer greater than or equal to 2), and the host controller 310 may include N interface circuits (e.g., a UIC layer) corresponding to the first through N-th storage devices.

According to an embodiment, the UFS host controller 320 may transmit a copy command requesting copying of data to the UFS device 200. The UFS host controller 320 may transmit at least one logical address along with a UFS copy command. For example, the UFS host controller 320 may transmit, to the UFS device 200, a source (SRC) LBA for indicating copy data that is to be copied, and a destination (DST) LBA for indicating a location where the copy data is to be copied. According to embodiments, internal commands/internal responses, payloads, etc. from the storage devices may be stored in a queue within the system on chip SoC or a queue within the host memory 301.

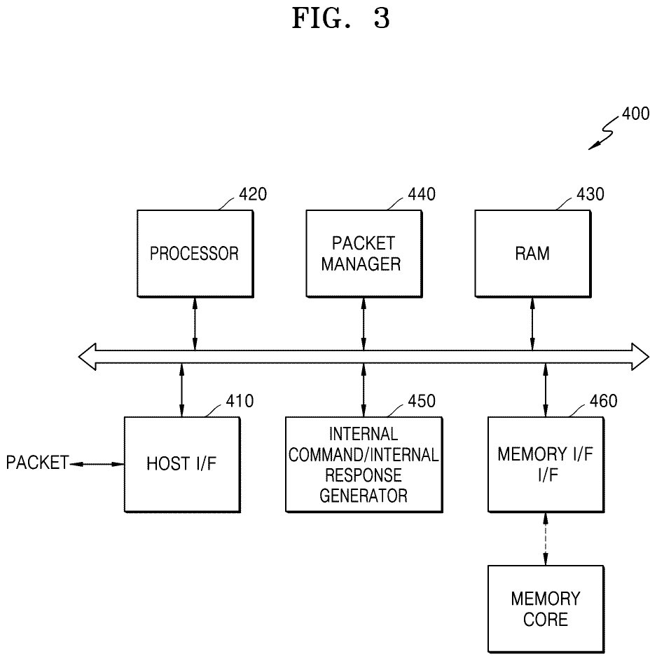

FIG. 3 is a block diagram of an implementation of a storage device according to one or more embodiments.

The storage device of FIG. 3 may correspond to the UFS device 200 of FIG. 1. Referring to FIG. 3, the storage device may include a memory controller 400 and a memory core. The memory controller 400 may include a host I/F 410, a processor 420, a RAM 430, a packet manager 440, an internal command/internal response generator 450, and a memory I/F 460. The RAM 430 may be used as a working memory, and the processor 420 may control the overall operation of the memory controller 400 by executing firmware loaded into the RAM 430. The RAM 430 may be implemented as various types of memory, for example, as at least one of resistive memory devices, such as a cache memory, a DRAM, an SRAM, and a Phase Change RAM (PRAM). As an example of the firmware, an FTL may be loaded into the RAM 430, and various functions related to a flash memory operation may be performed by driving the FTL.

The host I/F 410 may communicate with a host via various types of interfaces according to the above-described embodiment. The host I/F 410 may transmit and receive a packet to and from the host. According to the above-described embodiment, the packet may include an internal command/internal response or payload provided by any one storage device.

The packet manager 440 may generate a packet transmitted to the host according to a protocol of a preset interface, and/or may extract various types of information from a packet received from the host. The internal command/internal response generator 450 may generate an internal command that is to be provided to another storage device, or may generate an internal response in response to an internal command provided by the other storage device. The packet manager 440 may receive an internal command or internal response from the internal command/internal response generator 450, and may include the internal command or internal response in a specific region of the packet (e.g., a header region and/or an additional header region) when generating a packet. The packet manager 440 may receive various pieces of information related to an internal command or internal response (e.g., an ID of a target storage device and format information of the internal command) from the internal command/internal response generator 450, and may include the various types of information in the packet.

The memory I/F 460 may provide a physical connection between the memory controller 400 and the memory core. For example, the memory controller 400 may generate a command/address and a control signal both for controlling a memory operation, and may provide them to the memory core through the memory I/F 460. Write data and read data by the memory operation may be transmitted and/or received between the memory controller 400 and the memory core via the memory I/F 460.

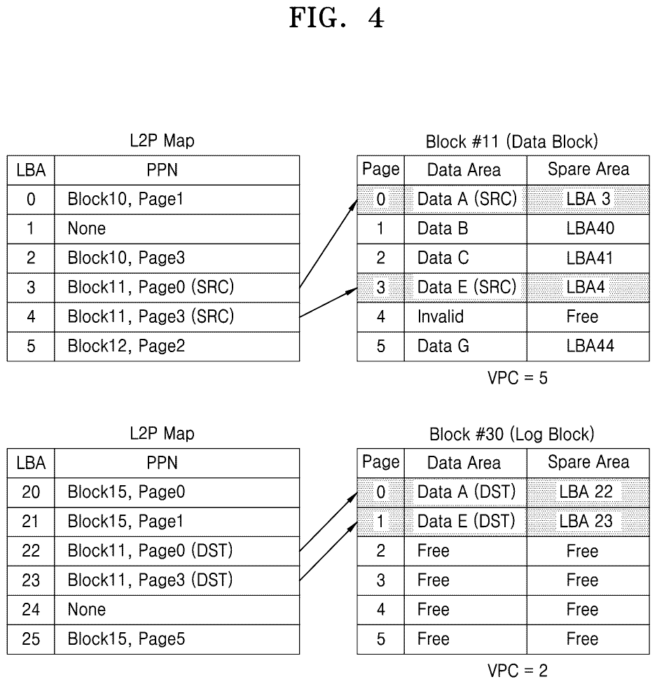

FIG. 4 illustrates changes in a logical-to-physical (L2P) map and a storage status according to a UFS copy command, according to a comparative example.

Referring to FIG. 4, a storage controller (e.g., the UFS device controller 220 of FIG. 1) may copy data in response to the UFS copy command. For example, the storage controller may receive the UFS copy command and one or more addresses. The one or more addresses may include an SRC LBA for indicating an address where target data representing a target of copying is stored, and a DST LBA for indicating an address where the target data is to be copied and newly written. For example, a host (e.g., the UFS host 100 of FIG. 1) may request that data in LBA 3 is copied to LBA 22 and data in LBA 4 is copied to LBA 23.

Referring to FIG. 4, SRC LBAs may be LBA 3 and LBA 4. The storage controller may refer to L2P map information in order to identify a location where the data in LBA 3 and the data in LBA 4 are actually physically stored. The L2P map information may include information about a mapping relationship between an LBA and a PBA. The storage controller may identify locations where the data of LBA 3 and the data of LBA 4 are actually stored, based on physical page numbers (PPNs) corresponding to LBA 3 and LBA 4. Referring to FIG. 4, the storage controller may identify that the data of LBA 3 has been written to page 0 of block 11 and the data of LBA 4 has been written to page 3 of block 11, by referring to the PPNs of LBA 3 and LBA 4 of the L2P map.

The storage controller may copy the data of LBA 3 and the data of LBA 4 to a new block. For example, the storage controller may read data from page 0 and page 3 of identified block 11, based on the L2P map, and load the data into an SRAM. Thereafter, the storage controller may program the data loaded into the SRAM into new PBAs. Referring to FIG. 4, the storage controller may write data A of LBA 3 to page 0 of a new block 30 based on a PPN corresponding to LBA22, and write data E of LBA 4 to page 1 of block 30 based on a PPN corresponding to LBA23.

The storage controller may update the L2P map information. To this end, the storage controller may map the DST LBA to a newly programmed PBA. For example, because the host has requested that data at LBA 3 is copied to LBA 22, the storage controller may map a PPN of LBA 22 to page 0 of block 30 to which data A is newly programmed. Because the host has requested that data at LBA 4 is copied to LBA 23, the storage controller may map a PPN of LBA 23 to page 1 of block 30 to which data E is newly programmed.

According to the above-described comparative example, transmission and reception of data A and data E, which are to be copied, between the host and a storage device may be omitted. However, because data transmission and reception still exists between an SRAM (e.g., the memory 250 of FIG. 1) and a storage memory (e.g., the memory unit of FIG. 1), latency of the copy command may be exposed to the host without changes.

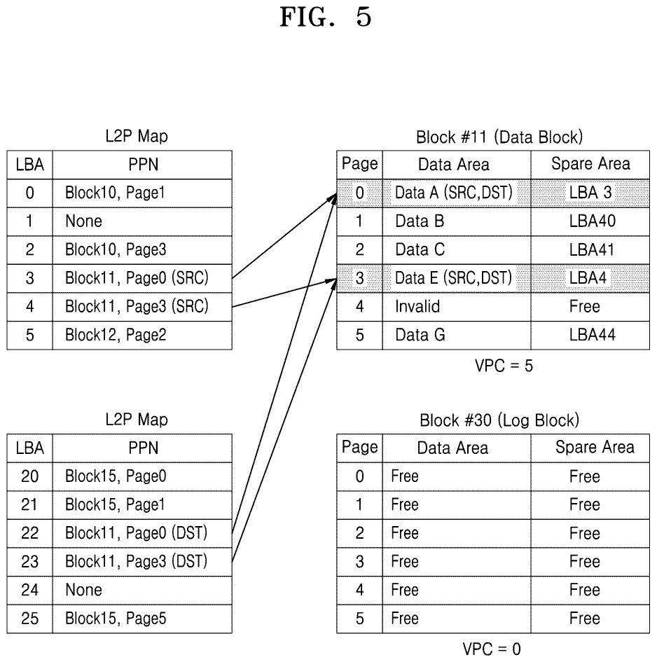

FIG. 5 illustrates changes in an L2P map and a storage status according to a UFS copy command, according to a comparative example.

Referring to FIG. 5, a storage controller (e.g., the UFS device controller 220 in FIG. 1) may copy data in response to a UFS copy command. For example, the storage controller may receive the UFS copy command and one or more addresses. The one or more addresses may include an SRC LBA for indicating an address where target data representing the target of copying is stored, and a DST LBA for indicating an address where the target data is to be copied and newly written. For example, a host (e.g., the UFS host 100 of FIG. 1) may request that data in LBA 3 is copied to LBA 22 and data in LBA 4 is copied to LBA 23.

Referring to FIG. 5, the storage controller may achieve the same effect as the copy command by changing only the L2P map information. For example, the storage controller may map LBA 22 to page 0 of block 11, and map LBA 23 to page 3 of block 11. This is because, even when the host requests data of LBA 22 and data of LBA 23 later, the storage controller reads data A from page 0 of block 11 mapped to LBA 22 and reads data E from page 3 of block 11 mapped to LBA 23. As in the comparative example of FIG. 5, even when only the L2P map information is changed without copying actual data, the same effect as copying data A and E to destination LBAs may be achieved, and, because the actual data is not copied, the data transmission and reception between the SRAM (e.g., the memory 250 of FIG. 1) and the storage memory (e.g., the memory unit of FIG. 1) described above with reference to FIG. 4 may be omitted, and thus the latency of the copy command may be eliminated.

However, when only a mapping relationship of a new LBA is newly set in the L2P map information, new mapping information according to the copy command may be lost, because a spare area of each page has not been modified (or because the spare area of each page cannot be modified because overwriting is not possible due to characteristics of a NAND). For example, a sudden power off (SPO) may occur. When an SPO occurs, the SRAM storing the L2P map information may be initialized. In this case, the storage controller may reconstruct the L2P map information by referring to the spare area of each page. The spare area may include information about which LBA the data stored in an actual PBA is mapped to. For example, referring to FIG. 5, the storage controller may restore a mapping relationship between LBA 3 and page 0 of block 11 by referring to the spare area of page 0 of block 11. According to the comparative example of FIG. 5, even when LBA 22 and LBA 23 in the L2P map information have been mapped to pages 0 and 3 of block 11, respectively, the spare areas of pages 0 and 3 of block 11 cannot be modified due to the NAND characteristics that overwriting is impossible, and thus, the spare areas of pages 0 and 3 of block 11 may still only point to LBA 3 and LBA 4. Therefore, when an SPO occurs and the L2P map is restored by referring to the spare area, the mapping information of LBA 22 and LBA 23 according to the copy command may not be restored.

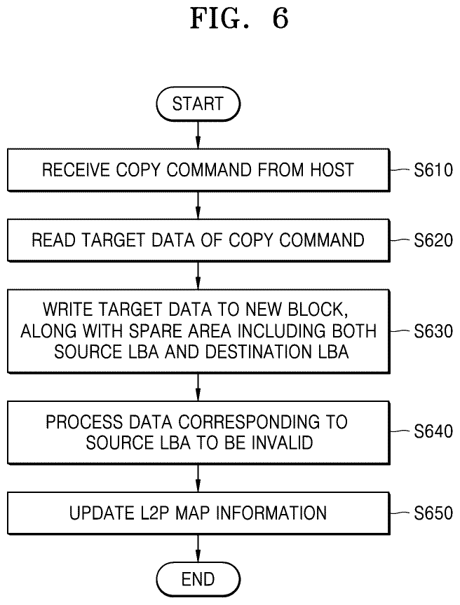

FIG. 6 is a flowchart of an operation method of a storage controller, according to one or more embodiments.

Referring to FIG. 6, in operation S610, the storage controller (e.g., the UFS device controller 220 of FIG. 1) may receive a copy command from a host (e.g., the UFS host 100 of FIG. 1). For example, the storage controller may receive, together with the copy command, an SRC LBA indicating the location of target data, which is the target of the copy command, and a DST LBA indicating the location to which the target data is to be copied.

In operation S620, the storage controller may read the target data of the copy command. The storage controller may read the target data based on the source LBA received along with the copy command from the host. To this end, the storage controller may identify the PPN mapped to the source LBA in the L2P map information to identify the location to which the target data has been actually written. The storage controller may read target data from the identified PPN, and temporarily store the read-out target data in an SRAM (e.g., the memory 250 of FIG. 1).

In operation S630, the storage controller may write the target data to a new block, along with writing a source logic block address (LBA) and a destination LBA to a spare area of the new block. The storage controller may write the target data loaded into the SRAM to a page of the new block. The storage controller may also write both the SRC LBA and the DST LBA to the spare area. This is because, as described above with reference to FIG. 5, when only the L2P map information is changed without changing the information of the spare area, data loss cannot be prevented when an events such as an SPO and garbage collection occur. When the storage controller writes the SRC LBA and the DST LBA to the spare area of the new block when writing the target data to the new block, the L2P map information of the SRC LBA and the DST LBA may be completely restored even when events such as an SPO and garbage collection occur.

In operation S640, the storage controller may process data corresponding to the SRC LBA to be invalid. In response to the storage controller completing writing of the target data, the storage controller may determine that the data in a PBA indicated by the PPN of the source LBA is duplicated, and may invalidate the data. For example, the storage controller may modify the PPN of the SRC LBA to a PBA to which the target data has been written.

In operation S650, the storage controller may update the L2P map information. The storage controller may write the PPN of the DST LBA to a PBA to which the target data has been written.

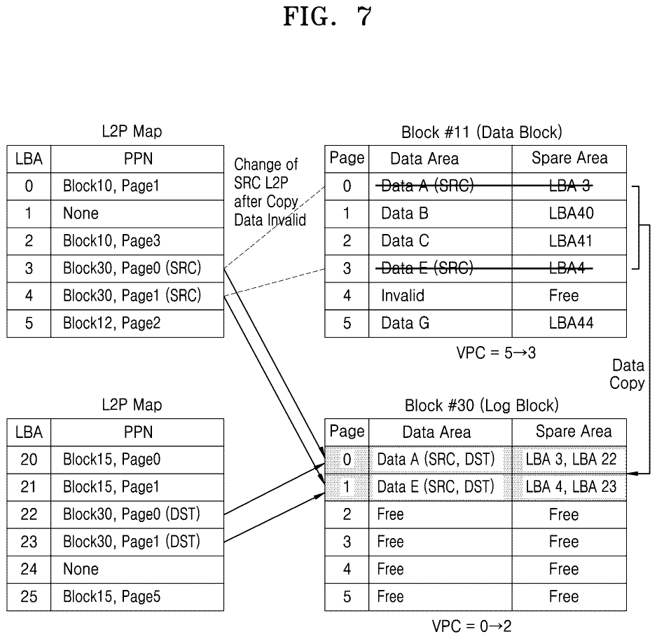

FIG. 7 illustrates changes in an L2P map and a storage status based on a UFS copy command, according to one or more embodiments.

Referring to FIG. 7, a storage controller (e.g., the UFS device controller 220 of FIG. 1) may copy data in response to the UFS copy command. For example, the L2P map may include a source (SRC) LBA for indicating an address where the UFS copy command and target data representing the target of copying are stored, and a DST LBA for indicating an address where the target data is to be copied and newly written. For example, a host may request that data in LBA 3 is copied to LBA 22 and data in LBA 4 is copied to LBA 23.

Referring to FIG. 7, SRC LBAs may be LBA 3 and LBA 4. The storage controller may refer to L2P map information in order to identify a location where the data in LBA 3 and the data in LBA 4 are actually physically stored. The L2P map information may include information about a mapping relationship between an LBA and a PBA. The storage controller may identify locations where the data of LBA 3 and the data of LBA 4 are actually stored, based on PPNs corresponding to LBA 3 and LBA 4. Referring to FIG. 7, the storage controller may identify that the data of LBA 3 has been written to page 0 of block 11 and the data of LBA 4 has been written to page 3 of block 11, by referring to the PPNs of LBA 3 and LBA 4 of the L2P map.

The storage controller may copy the data of LBA 3 and the data of LBA 4 to a new block. For example, the storage controller may read data from page 0 and page 3 of identified block 118, based on the L2P map, and load the data into an SRAM. Thereafter, the storage controller may program the data loaded into the SRAM into a page of the new block. Referring to FIG. 4, the storage controller may write data A of LBA 3 to page 0 of a new block 30 based on a PPN corresponding to LBA22, and write data E of LBA 4 to page 1 of block 30 based on a PPN corresponding to LBA23.

According to an embodiment, the storage controller may write the SRC LBA and the DST LBA to the spare area. For example, while writing data A to page 0 of block 30, the storage controller may write the SRC LBA and the DST LBA to the spare area of the page 0 of block 30. The storage controller may write data A, which is the target data, to a data area of page 0 of block 30, and may write LBA 3, which is the SRC LBA, and LBA 22, which is the DST LBA, to the spare area of page 0 of block 30. The storage controller may write data E, which is the target data, to a data area of page 1 of block 30, and may write LBA 4, which is the SRC LBA, and LBA 23, which is the DST LBA, to the spare area of page 1 of block 30.

According to an embodiment, the storage controller may update the L2P map information. The storage controller may modify both the SRC LBA and the DST LBA of the L2P map information.

The storage controller may modify a PPN corresponding to the SRC LBA of the L2P map information. For example, the storage controller may change the PPN of the SRC LBA from an existing location to a location where new writing is performed. Referring to FIG. 7, the storage controller may modify the PPN of LBA 3 from page 0 of the existing block 11 to page 0 of block 30. The storage controller may modify the PPN of LBA 4 from page 3 of the existing block 11 to page 1 of block 30.

The storage controller may write a PPN corresponding to the DST LBA of the L2P map information. For example, the storage controller may input the PPN of the DST LBA to the location where new writing is performed. Referring to FIG. 7, the storage controller may set the PPN of LBA 22 to page 0 of block 30 and set the PPN of LBA 23 to page 1 of block 30.

According to an embodiment, by writing both the source LBA and the destination LBA to the spare area while writing target data to be copied to a new block in response to the copy command, an effect of the copy command based on a multiple-to-one mapping between logical addresses and physical addresses may be achieved even when P2L map information is not generated.

According to an embodiment, an effect of refreshing data may be obtained by rewriting target data of the copy command to a new block. For example, when data has been written to pages 0 and 3 of the existing block 11 for a long time, read errors may occur due to cell leakage over time. The read errors may be prevented by rewriting the target data to a new block whenever the copy command is received.

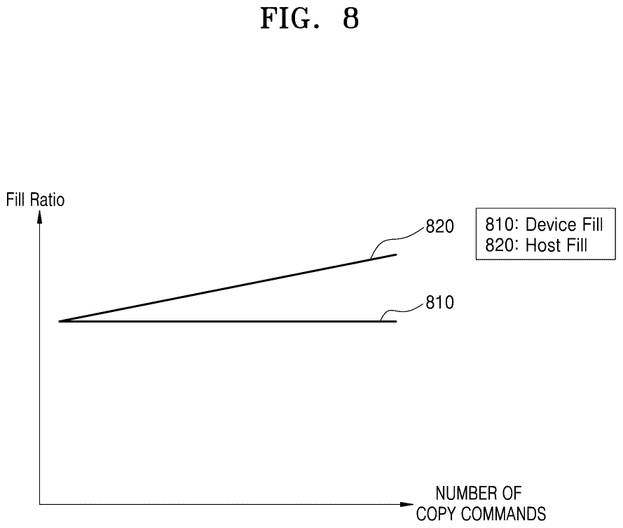

FIG. 8 is a graph showing a change in a fill ratio according to a number of copy commands, according to one or more embodiments.

Referring to FIG. 8, an X-axis of a graph may represent a number of copy commands. A Y-axis of the graph may represent a fill ratio.

A first result 810 may represent a fill ratio of a storage device (e.g., the UFS device 200 of FIG. 1). The fill ratio of the storage device may be maintained regardless of the number of copy commands. According to an embodiment, valid page count (VPC) values before and after the copy command may be maintained. For example, referring to FIG. 7, a VPC value of block 11 before the copy command is performed may be 5 and a VPC value of block 30 before the copy command is performed may be 0. According to one or more embodiment, by invalidating the existing location of the target data, a VPC value of block 11 after the copy command is performed may be reduced to 3, and a VPC value of block 30 after the copy command is performed may be increased to 2. Therefore, a sum of the VPC values of block 11 and block 30 may be maintained the same before and after execution of the copy command.

A second result 820 may represent a fill ratio perceived by a host (e.g., the UFS host 100 of FIG. 1). The fill ratio perceived by the host may increase in proportion to the number of copy commands. Before and after execution of the copy command according to the disclosure, logical addresses and physical addresses may be mapped in a multiple-to-one manner. In other words, because the fill ratio perceived by the host is proportional to the number of mapped LBAs, the fill ratio may increase in proportion to the number of copy commands.

The storage controller may use a difference between the host's fill ratio and the storage device's fill ratio in over provisioning (OP). As described above, as the number of copy commands increases, the difference between the fill ratio perceived by the host and the fill ratio of the storage device may increase. That is, because the difference is blind only to the host, the difference between the host's fill ratio and the storage device's fill ratio may be utilized in OP to help an overall operation of the storage device.

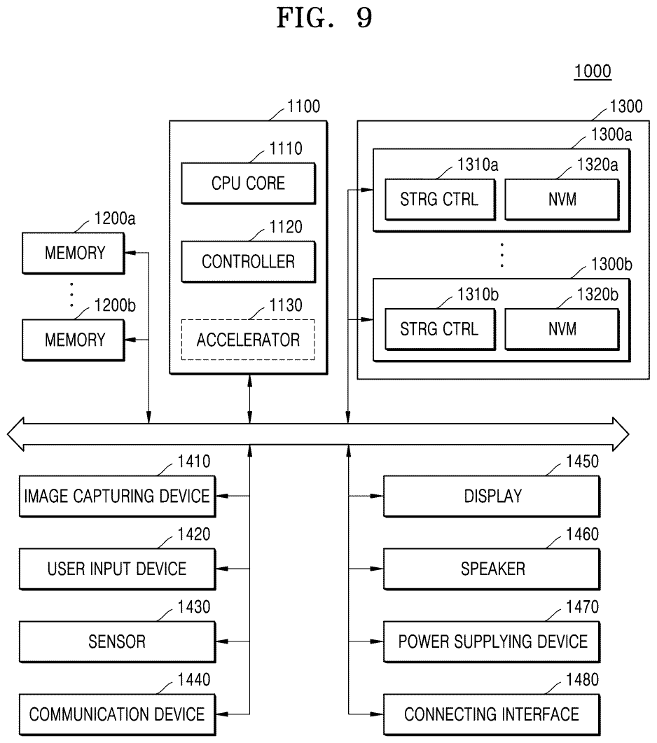

FIG. 9 is a block diagram of a system 1000 including a storage device, according to one or more embodiments.

The system 1000 of FIG. 9 may include, for example but not limited to, a mobile system, such as a mobile phone, a smartphone, a tablet personal computer (PC), a wearable device, a health care device, or an Internet of things (IoT) device. However, the system 1000 of FIG. 9 is not necessarily limited to the mobile system, and may include, for example but not limited to, a PC, a laptop computer, a server, a media player, an automotive device (such as, a navigation device), etc.

Referring to FIG. 9, the system 1000 may include a main processor 1100, memories 1200a and 1200b, and a storage system 1300, and may further include one or more of an image capturing device 1410, a user input device 1420, a sensor 1430, a communication device 1440, a display 1450, a speaker 1460, a power supplying device 1470, and a connecting interface 1480. Each of components constituting the system 1000 of FIG. 9, namely, the main processor 1100, the memories 1200a and 1200b, the storage system 1300, the photographing device 1410, the user input device 1420, the sensor 1430, the communication device 1440, the display 1450, the speaker 1460, the power supplying device 1470, and the connecting interface 1480, may be implemented using one or more embodiments described above with reference to FIGS. 1 through 8.

The main processor 1100 may control an overall operation of the system 1000, and more particularly, operations of other components constituting the system 1000. The main processor 1100 may be implemented as a general-purpose processor, a dedicated processor, an AP, or the like.

The main processor 1100 may include one or more CPU cores 1110, and may further include a controller 1120 for controlling the memories 1200a and 1200b and/or the storage system 1300. According to an embodiment, the main processor 1100 may further include an accelerator 1130, which is a dedicated circuit for a high-speed data operation such as an artificial intelligence (AI) data operation. The accelerator 1130 may include a graphics processing unit (GPU), a neural processing unit (NPU), and/or a data processing unit (DPU), and may be implemented as a separate chip physically independent from other components of the main processor 1100.

The memories 1200a and 1200b may be used as a main memory device of the system 1000, and may include volatile memories, such as an SRAM and/or a DRAM, but may include non-volatile memories, such as a flash memory, a PRAM, and/or an RRAM. The memories 1200a and 1200b may be implemented together with the main processor 1100 in the same package.

The storage system 1300 may include a storage device 1300a and a storage device 1300b. The storage device 1300a and the storage device 1300b may be configured to be included in a single memory package. The storage devices 1300a and 1300b may function as non-volatile storage devices that store data regardless of whether power is supplied or not thereto, and may have a relatively larger storage capacity than the memories 1200a and 1200b. Each of the storage devices 1300a and 1300b may include storage controllers 1310a and 1310b and non-volatile memories (NVMs) 1320a and 1320b for storing data under the control by the storage controllers 1310a and 1310b. The NVMs 1320a and 1320b may include, for example but not limited to, flash memories that have a 2-dimensional (2D) structure or a 3-dimensional (3D) Vertical NAND (V-NAND) structure, but may include other types of NVMs such as, for example but not limited to, a PRAM and/or an RRAM.

The storage system 1300 may be included in the system 1000 in a state of being physically separated from the main processor 1100, or may be implemented together with the main processor 1100 in the same package. The storage system 1300 may be configured as a solid state device (SSD) or a memory card, and thus may be detachably coupled to other components of the system 1000 through an interface such as the connecting interface 1480, which will be described later. The storage system 1300 may be a device to which a standard protocol such as a UFS is applied, but is not limited thereto.

According to an embodiment, the storage device 1300a may perform 2-LANE communication with the main processor 1100, and the storage device 1300b may also perform 2-LANE communication with the main processor 1100. In this case, the storage system 1300 may perform 4-LANE communication with the main processor 1100.

The image capturing device 1410 may capture a still image or a moving picture, and may be a camera, a camcorder, and/or a webcam.

The user input device 1420 may receive various types of data input from a user of the system 1000, and may include, for example but not limited to, a touch pad, a keypad, a keyboard, a mouse, and/or a microphone.

The sensor 1430 may detect various types of physical quantities that may be obtained from an outside of the system 1000, and may convert the sensed physical quantities into electrical signals. The sensor 1430 may include, for example but not limited to, a temperature sensor, a pressure sensor, an illuminance sensor, a position sensor, an acceleration sensor, a biosensor, and/or a gyroscope sensor.

The communication device 1440 may transmit and receive signals to and from other devices outside the system 1000 according to various communication protocols. The communication device 1440 may be implemented by including an antenna, a transceiver, and/or a modem.

The display 1450 and the speaker 1460 may function as output devices that respectively output visual information and auditory information to the user of the system 1000.

The power supplying device 1470 may appropriately convert power supplied from a battery (not shown) built into the system 1000 and/or an external power source, and may supply the converted power to each component of the system 1000.

The connecting interface 1480 may provide a connection between the system 1000 and an external device connected to the system 1000 to exchange data with the system 1000. The connecting interface 1480 may be implemented in various interface methods such as, for example but not limited to, Advanced Technology Attachment (ATA), Serial ATA (SATA), external-SATA (e-SATA), a Small Computer System Interface (SCSI), a Statistical Analysis System (SAS), a Peripheral Component Interconnect (PCI), PCI express (PCIe), Non-Volatile Memory express (NVMe), Institute of Electrical and Electronics Engineers (IEEE) 1394, a Universal Serial Bus (USB), a Secure Digital (SD) card, a Multi Media Card (MMC), an embedded MMC (eMMC), a Universal Flash Storage (UFS), an embedded Universal Flash Storage (eUFS), and a Compact Flash (CF) card interface.

The disclosure has been particularly shown and described with reference to example embodiments thereof. The terminology used herein is for the purpose of describing example embodiments only and is not intended to be limiting of the disclosure. Therefore, it is to be understood by those skilled in the art that various changes in form and details may be made therein without departing from the spirit and scope of the disclosure as defined by the appended claims and their equivalents.

While the disclosure has been particularly shown and described with reference to example embodiments thereof, it is to be understood that various changes in form and details may be made therein without departing from the spirit and scope of the following claims.

What is claimed is:

1. An operation method of a storage controller, the operation method comprising:
receiving, from a host, a copy command, a source logic block address (LBA), and a destination LBA;
reading target data at a first location corresponding to the source LBA, based on logical to physical (L2P) map information, and loading the target data into a static random access memory (SRAM); and
writing the target data to a data area of a new block at a second location, and writing the source LBA and the destination LBA to a spare area of the new block.

2. The operation method of claim 1, wherein the receiving from the host is based on a connection to the host via a universal flash storage (UFS) interface.

3. The operation method of claim 1, further comprising, in response to completion of the writing, invalidating the target data at the first location by changing a physical page number (PPN) value corresponding to the source LBA among the L2P map information from the first location to the second location.

4. The operation method of claim 3, further comprising setting a PPN value corresponding to the destination LBA among the L2P map information to the second location.

5. The operation method of claim 4, further comprising, in response to completion of the setting, transmitting a response indicating completion of the copy command to the host.

6. The operation method of claim 4, wherein a sum of a first valid page count (VPC) value of a block including the first location and a second VPC value of a block including the second location remains constant.

7. The operation method of claim 3, wherein at least one page corresponding to the first location corresponds to an area for over provisioning (OP).

8. A storage device comprising:
a plurality of non-volatile memory devices; and
a storage controller,
wherein the storage controller is configured to receive a copy command, a source logical block address (LBA), and a destination LBA from a host, read target data at a first location corresponding to the source LBA, based on logical to physical (L2P) map information, load the target data into a static random access memory (SRAM), write the target data to a data area of a new block at a second location, and write the source LBA and the destination LBA to a spare area of the new block.

9. The storage device of claim 8, wherein the storage device is configured to communicate with the host via a universal flash storage (UFS) interface.

10. The storage device of claim 8, wherein, in response to completion of the writing, the storage controller is further configured to invalidate the target data at the first location by changing a physical page number (PPN) value corresponding to the source LBA among the L2P map information from the first location to the second location.

11. The storage device of claim 10, wherein the storage controller is further configured to set a PPN value corresponding to the destination LBA among the L2P map information to the second location.

12. The storage device of claim 11, wherein, in response to completion of the setting, the storage controller is further configured to transmit a response indicating completion of the copy command to the host.

13. The storage device of claim 11, wherein a sum of a first valid page count (VPC) value of a block including the first location and a second VPC value of a block including the second location remains constant.

14. The storage device of claim 10, wherein at least one page corresponding to the first location corresponds to an area for over provisioning (OP).

15. A memory system comprising:
a host configured to transmit, to a storage device, a copy command requesting that target data at a source logical block address (LBA) is copied to a destination LBA; and
the storage device including a storage controller,
wherein the storage controller is configured to receive the copy command, the source LBA, and the destination LBA from the host, read the target data at a first location corresponding to the source LBA, based on logical to physical (L2P) map information, and load the target data into a static random access memory (SRAM), write the target data to a data area of a new block at a second location, and write the source LBA and the destination LBA to a spare area of the new block.

16. The memory system of claim 15, wherein the host is further configured to communicate with the storage device via a universal flash storage (UFS) interface.

17. The memory system of claim 15, wherein, in response to completion of the writing, the storage controller is further configured to invalidate the target data at the first location by changing a physical page number (PPN) value corresponding to the source LBA among the L2P map information from the first location to the second location.

18. The memory system of claim 17, wherein the storage controller is further configured to set a PPN value corresponding to the destination LBA among the L2P map information to the second location.

19. The memory system of claim 18, wherein, in response to completion of the setting, the storage controller is further configured to transmit a response indicating completion of the copy command to the host.

20. The memory system of claim 18, wherein a sum of a first valid page count (VPC) value of a block including the first location and a second VPC value of a block including the second location remains constant.
